(19) United States
(12) Patent Application Publication
(10) Pub. No.: US 2025/0069817 A1
(43) Pub. Date: Feb. 27, 2025

(54) METHOD FOR MANUFACTURING MEMBER OF CAPACITOR, CAPACITOR, ELECTRICAL CIRCUIT, CIRCUIT BOARD, APPARATUS, AND POWER STORAGE DEVICE

(71) Applicant: Panasonic Intellectual Property Management Co., Ltd., Osaka (JP)

(72) Inventors: Manabu KANOU, Osaka (JP); Ryosuke KIKUCHI, Osaka (JP)

(21) Appl. No.: 18/945,152

(22) Filed: Nov. 12, 2024

Related U.S. Application Data
(63) Continuation of application No. PCT/JP2023/016106, filed on Apr. 24, 2023.

(30) Foreign Application Priority Data
May 13, 2022 (JP) 2022-079817

(51) Int. Cl. H01G 9/00; H01G 2/06; H01G 9/15

(52) U.S. Cl. CPC H01G 9/0032; H01G 9/0036; H01G 9/15; H01G 2/065

(57) ABSTRACT

A method for manufacturing a member of a capacitor according to the present disclosure includes forming a modified layer on a valve metal by a cathodic reaction, the modified layer including a metal other than the valve metal. In the manufacturing method, a requirement ε_{H}/K_{H} [V/nm]>ε_{L}/K_{L} [V/nm] is satisfied, where ε_{H} is a dielectric constant of an oxide of the metal, K_{H} [nm/V] is a thickness of a first oxide film of the metal, in formation of the first oxide film by anodic oxidation of the metal, per 1 V of anode potential, EL is a dielectric constant of an oxide of the valve metal, and K_{L} [nm/V] is a 10 thickness of a second oxide film including the oxide of the valve metal, in formation of the second oxide film by anodic oxidation, per 1 V of anode potential.

This application is a continuation of PCT/JP2023/016106 filed on Apr. 24, 2023, which claims foreign priority of Japanese Patent Application No. 2022-079817 filed on May 13, 2022, the entire contents of both of which are incorporated herein by reference.

### BACKGROUND OF THE INVENTION

### 1. Field of the Invention

The present disclosure relates to a method for manufacturing a member of a capacitor, a capacitor, an electrical circuit, a circuit board, an apparatus, and a power storage device.

### 2. Description of Related Art

Metals such as Al, Ta, Nb, Zr, and Hf have been known as valve metals. Anodic oxidation of valve metals in a given solution forms insulating oxide films. For example, Al and Ta can produce porous bodies with large surface areas, and Al electrolytic capacitors and Ta electrolytic capacitors are widely used.

In Atsushi TANAKA and Hideaki TAKAHASHI: “The Structure and Growth Mechanism of Anodic Barrier Films of Aluminum”, Journal of the Surface Finishing Society of Japan, 2018, 69(12), 542-553, Table 1 lists the permittivities of anodic oxide films of valve metals. The table indicates that Al₂O₃ has the second lowest permittivity after SiO₂. Atsushi TANAKA and Hideaki TAKAHASHI: “The Structure and Growth Mechanism of Anodic Barrier Films of Aluminum”, Journal of the Surface Finishing Society of Japan, 2018, 69(12), 542-553 describes the formation of SiO₂, Ta₂O₅, Nb₂O₅, ZrO₂, TiO₂, and BaTiO₂ thin films on Al plates using a sol-gel method. This literature further describes obtaining composite barrier-type anodic oxide films (BAOFs) by anodic oxidation in a neutral solution.

Crossland, A. C., Thompson, G. E., Skeldon, P., Wood, G. C., Smith, C. J. E., Habazaki, H., & Shimizu, K. (1998). Anodic oxidation of Al-Ce alloys and inhibitive behaviour of cerium species. Corrosion science, 40(6), 871-885 describes anodic oxidation of Al-Ce alloys. The Al-Ce alloys are prepared by sputtering. The films formed on the Al-Ce alloys by anodic oxidation of the Al-Ce alloys include an inner oxide layer and an outer oxide layer. The inner oxide layer represents the main part of the film thickness and contains alumina and a cerium oxide. The outer oxide layer is a layer enriched in cerium species. According to Crossland, A. C., Thompson, G. E., Skeldon, P., Wood, G. C., Smith, C. J. E., Habazaki, H., & Shimizu, K. (1998). Anodic oxidation of Al-Ce alloys and inhibitive behaviour of cerium species. Corrosion science, 40(6), 871-885, cerium species can function as anodic inhibitors of aluminum corrosion in both weakly and strongly alkaline solutions. The description in Crossland, A. C., Thompson, G. E., Skeldon, P., Wood, G. C., Smith, C. J. E., Habazaki, H., & Shimizu, K. (1998). Anodic oxidation of Al-Ce alloys and inhibitive behaviour of cerium species. Corrosion science, 40(6), 871-885 is understood to be based on the examination of alternative wet processes aimed at reducing the use of chromates; these processes can provide corrosion resistance to aluminum alloys and form a base for subsequent surface treatments, such as painting.

### SUMMARY OF THE INVENTION

The present disclosure provides a method for manufacturing a novel member of a capacitor, where the member includes a dielectric including a given metal such as cerium.

A method for manufacturing a member of a capacitor of the present disclosure includes forming a modified layer on a valve metal by a cathodic reaction, the modified layer including a metal other than the valve metal, wherein
a requirement ε_{H}/K_{H} [V/nm]>ε_{L}/K_{L} [V/nm] is satisfied, where
ε_{H} is a dielectric constant of an oxide of the metal,
K_{H} [nm/V] is a thickness of a first oxide film of the metal, in formation of the first oxide film by anodic oxidation of the metal, per 1 V of anode potential,
ε_{L} is a dielectric constant of an oxide of the valve metal, and
K_{L} [nm/V] is a thickness of a second oxide film including the oxide of the valve metal, in formation of the second oxide film by anodic oxidation, per 1 V of anode potential.

According to the present disclosure, it is possible to manufacture a novel member of a capacitor, where the member includes a dielectric including a given metal such as cerium.

### BRIEF DESCRIPTION OF THE DRAWINGS

FIG. 1 is a flowchart showing an example of a method for manufacturing a member of a capacitor.

FIG. 2A is a cross-sectional view showing an example of a capacitor of the present disclosure.

FIG. 2B is a cross-sectional view showing another example of the capacitor of the present disclosure.

FIG. 2C is a cross-sectional view showing a modification of the capacitor shown in FIG. 2B.

FIG. 3A schematically shows an example of an electrical circuit of the present disclosure.

FIG. 3B schematically shows an example of a circuit board of the present disclosure.

FIG. 3C schematically shows an example of an apparatus of the present disclosure.

FIG. 3D schematically shows an example of a power storage device of the present disclosure.

FIG. 4 is a potential-pH diagram showing the state of cerium in water.

FIG. 5 is a flowchart showing another example of the method for manufacturing the member of a capacitor.

FIG. 6 is a graph showing the X-ray diffraction (XRD) pattern of a member of a capacitor according to an example and the results of calculating the XRD patterns of Al and CeO₂.

FIG. 7 is a graph showing, as determined by time-of-flight secondary ion mass spectrometry (TOF-SIMS) on the member of a capacitor according to the example, the relationship between the signal intensities of AlO⁺, CeO⁺, and C⁺ and the depth of the member of a capacitor.

### DETAILED DESCRIPTION

### Findings Underlying the Present Disclosure

In the technique described in Atsushi TANAKA and Hideaki TAKAHASHI: “The Structure and Growth Mechanism of Anodic Barrier Films of Aluminum”, Journal of the Surface Finishing Society of Japan, 2018, 69(12), 542-553, SiO₂, Ta₂O₅, Nb₂O₅, ZrO₂, TiO₂, and BaTiO₂ thin films are formed on Al plates by a sol-gel method that does not involve an oxidation-reduction reaction, which is an electrochemical reaction. Therefore, it is considered difficult to uniformly coat porous bodies with these thin films to a thickness suitable for capacitors. Crossland, A. C., Thompson, G. E., Skeldon, P., Wood, G. C., Smith, C. J. E., Habazaki, H., & Shimizu, K. (1998). Anodic oxidation of Al-Ce alloys and inhibitive behaviour of cerium species. Corrosion science, 40(6), 871-885 does not intend to apply articles obtained by anodic oxidation of Al-Ce alloys to capacitors. In the technique described in Crossland, A. C., Thompson, G. E., Skeldon, P., Wood, G. C., Smith, C. J. E., Habazaki, H., & Shimizu, K. (1998). Anodic oxidation of Al-Ce alloys and inhibitive behaviour of cerium species. Corrosion science, 40(6), 871-885, Al-Ce alloys are used as a base, and thus making the surface of the base porous is considered difficult. Therefore, the technique described in Crossland, A. C., Thompson, G. E., Skeldon, P., Wood, G. C., Smith, C. J. E., Habazaki, H., & Shimizu, K. (1998). Anodic oxidation of Al-Ce alloys and inhibitive behaviour of cerium species. Corrosion science, 40(6), 871-885 is disadvantageous from the perspective of application to capacitors.

A charge amount Q [C] stored in a capacitor is typically expressed by Equation (1). In Equation (1), C is the capacitance and V is the applied voltage. In addition, ε₀ is the permittivity of vacuum, ε is the dielectric constant of the dielectric between the electrodes of the capacitor, S is the electrode surface area of the capacitor, and t is the distance between the electrodes, equivalent to the thickness of the dielectric.

$${Q}_{max} = {ε}_{0} \cdot ε \cdot ( S / t ) \cdot {V}_{max} = {ε}_{0} \cdot S \cdot ( ε / K ) \qquad Equation ( 2 )$$

In the case where a dielectric layer of a valve metal oxide or the like is formed by an electrochemical reaction of a valve metal, the thickness of the dielectric layer increases roughly in proportion to the applied voltage. When a voltage exceeding the applied voltage required for an electrochemical reaction is applied to a valve metal, film growth occurs due to current flow. Accordingly, in the use of capacitors, the withstand voltage of a film obtained by an electrochemical reaction is determined by an applied voltage that enables an electrochemical reaction to form a dielectric layer.

A maximum capacitance Qₘₐₓ of a capacitor including a dielectric layer formed by an electrochemical reaction is expressed by Equation (2) based on Equation (1). In Equation (2), Vₘₐₓ is the applied voltage for forming the dielectric layer, and K is the proportionality constant [nm/V] between an applied voltage Vₘₐₓ and a thickness t of the dielectric layer.

$$Q = C \cdot V = {ε}_{0} \cdot ε \cdot ( S / t ) \cdot V \qquad Equation ( 1 )$$

In Equation (2), S is determined by the capacitor structure, while ε and K are each an intrinsic value determined by the substance of the dielectric layer; ε is the dielectric constant of the substance of the dielectric layer, and K is the proportionality constant between the thickness of the dielectric layer and the applied voltage in the formation of the dielectric layer. It is understood that using a material with high ε/K as the dielectric of a capacitor is crucial for increasing the capacitance of the capacitor.

The values of ε, K, and ε/K in Equation (2) for valve metal oxides and CeO₂ are listed in Table 1.

TABLE 1

| | | Dielectric | K | ε/K |
|---|---|---|---|---|
| | Form | constant ε | [nm/V] | [V/nm] |
| TiO₂ | Crystalline | 90 | 3.0 | 30.0 |
| WO₃ | Amorphous | 41.7 | 1.8 | 23.2 |
| CeO₂ | Crystalline | 26 | 1.3 | 20 |
| Nb₂O₅ | Amorphous | 41.4 | 2.5 | 16.6 |
| Ta₂O₅ | Amorphous | 27.6 | 1.7 | 16.2 |
| ZrO₂ | Crystalline | 23 | 2.0 | 11.5 |
| HfO₂ | Crystalline | 21 | 1.9 | 11.1 |
| SiO₂ | Amorphous | 3.5 | 0.4 | 8.9 |
| Al₂O₃ | Amorphous | 9.8 | 1.4 | 7.0 |
| Bi₂O₃ | Amorphous | 40.3 | 10 | 4.0 |
| Y₂O₃ | Amorphous | 16.5 | 1.2 | 13.7 |

As shown in Table 1, for example, CeO₂ has higher ε/K than Al₂O₃ and Ta₂O₅, which are commonly used as dielectrics in electrolytic capacitors. Accordingly, it is expected that the performance of capacitors is enhanced by forming a layer including a given metal such as cerium on a layer including an oxide of a valve metal having a surface that can be made porous, such as Al and Ta. On the other hand, when an insulating film is formed by anodic oxidation of a valve metal, anodic oxidation can be performed under neutral conditions around pH 7. Under neutral conditions, a given metal such as cerium exhibits water solubility. It is thus difficult to form a layer including a given metal such as cerium on a layer including a valve metal oxide by using an aqueous solution used for anodic oxidation.

In view of such circumstances, the present inventors have made much trial and error, and as a result have finally found a novel method that can form a layer including a given metal such as cerium on a layer including a valve metal oxide. On the basis of this novel finding, the present inventors have devised a method for manufacturing a member of a capacitor of the present disclosure.

### Outline of one Aspect According to the Present Disclosure

A method for manufacturing a member of a capacitor according to a first aspect of the present disclosure includes forming a modified layer on a valve metal by a cathodic reaction, the modified layer including a metal other than the valve metal, wherein
a requirement ε_{H}/K_{H} [V/nm]>ε_{L}/K_{L} [V/nm] is satisfied, where
ε_{H} is a dielectric constant of an oxide of the metal,
K_{H} [nm/V] is a thickness of a first oxide film of the metal, in formation of the first oxide film by anodic oxidation of the metal, per 1 V of anode potential,
ε_{L} is a dielectric constant of an oxide of the valve metal, and
K_{L} [nm/V] is a thickness of a second oxide film including the oxide of the valve metal, in formation of the second oxide film by anodic oxidation, per 1 V of anode potential.

According to the first aspect, since a given modified layer can be formed on a valve metal by a cathodic reaction, a layer including a given metal such as cerium can be formed on a layer including a valve metal oxide. Therefore, it is possible to obtain a member of a capacitor that is advantageous for increasing the capacitance of a capacitor.

In a second aspect of the present disclosure, for example, the method for manufacturing the member of a capacitor according to the first aspect may further include forming a first layer and a second layer by anodic oxidation of the valve metal and the modified layer, the first layer including the substance, the second layer including the oxide of the valve metal. According to the second aspect, by the anodic oxidation of the valve metal and the modified layer, a layer including a given metal such as cerium can be formed on a layer including a valve metal oxide.

In a third aspect of the present disclosure, for example, the method for manufacturing the member of a capacitor according to the first or second aspect may be such that the metal is cerium. According to the third aspect, it is likely to obtain a member of a capacitor that is more advantageous for increasing the capacitance of a capacitor because CeO₂ has higher ε/K than Al₂O₃ and Ta₂O₅, which are commonly used as dielectrics in electrolytic capacitors.

A method for manufacturing a member of a capacitor according to a fourth aspect of the present disclosure includes:
forming a cerium-containing layer including cerium on a valve metal by a cathodic reaction of the valve metal in a cerium-containing solution; and
forming a first layer and a second layer by anodic oxidation of the valve metal and the cerium-containing layer, the first layer including cerium, the second layer including a valve metal oxide, wherein
in a thickness direction of the first layer, the second layer is disposed between the first layer and the valve metal and is in contact with the valve metal.

According to the fourth aspect, although cerium exhibits water solubility under neutral conditions, it is possible to provide a member of a capacitor including the first layer including cerium and the second layer including a valve metal oxide. Furthermore, in the member of a capacitor, in the thickness direction of the first layer, the second layer is disposed between the first layer and the valve metal and is in contact with the valve metal. Therefore, it is possible to provide a member of a capacitor that is advantageous for increasing the capacitance of a capacitor.

In a fifth aspect of the present disclosure, for example, the method for manufacturing the member of a capacitor according to the fourth aspect may be such that the cerium-containing solution includes hydrogen peroxide. According to the fifth aspect, the cathodic reaction of the valve metal in the cerium-containing solution is likely to form a desired cerium-containing layer.

In a sixth aspect of the present disclosure, for example, the method for manufacturing the member of a capacitor according to the fourth or fifth aspect may be such that an electrolyte solution including an organic solvent is used for the anodic oxidation. According to the sixth aspect, in the anodic oxidation of the valve metal and the cerium-containing layer, cerium is less prone to dissolution in the electrolyte solution and the first layer is likely to have an increased cerium concentration.

A capacitor according to a seventh aspect of the present disclosure includes:
a first electrode;
a second electrode including a valve metal and having a cerium content of less than 0.1% in terms of number of atoms; and
a dielectric disposed between the first electrode and the second electrode, wherein
the dielectric includes:
a first layer including cerium; and
a second layer including a valve metal oxide and being, in a thickness direction of the first layer, disposed between the first layer and the second electrode and in contact with the second electrode.

According to the seventh aspect, it is possible to provide a novel capacitor including a cerium-containing dielectric. In this capacitor, the dielectric includes a first layer including cerium and a second layer including a valve metal oxide. In the thickness direction of the first layer, the second layer is disposed between the first layer and the second electrode and is in contact with the second electrode. With this configuration, in the capacitor according to the seventh aspect, the dielectric is likely to have increased ε/K. Therefore, as can be seen from Equation (2) above, the maximum capacitance Qₘₐₓ of the capacitor is likely to be increased and the capacitor is likely to have a high capacitance.

In an eighth aspect of the present disclosure, for example, the capacitor according to the seventh aspect may be such that the first layer further includes a valve metal oxide. According to the eighth aspect, even in the case where the first layer includes a valve metal oxide, the capacitor is likely to have a high capacitance owing to the first layer including cerium.

In a ninth aspect of the present disclosure, for example, the capacitor according to the seventh or eighth aspect may be such that the valve metal included in the second electrode is aluminum. According to the ninth aspect, the second electrode is likely to have a porous surface and the capacitor is likely to have an increased electrode surface area. Therefore, the capacitor is more likely to have a high capacitance.

In a tenth aspect of the present disclosure, for example, the capacitor according to the ninth aspect may be such that the valve metal oxide included in the second layer is an aluminum oxide. According to the tenth aspect, the second electrode is likely to have a porous surface and the capacitor is likely to have an increased electrode surface area. Therefore, the capacitor is more likely to have a high capacitance.

In an eleventh aspect of the present disclosure, for example, the capacitor according to any one of the seventh to tenth aspects may be such that the first layer has a lower cerium concentration at a second position thereof than at a first position thereof, the second position being closer to the second layer than the first position is in the thickness direction of the first layer. According to the eleventh aspect, the cerium concentration in the first layer is likely to achieve a desired distribution and the capacitor is likely to have a high capacitance.

In a twelfth aspect of the present disclosure, for example, the capacitor according to any one of the seventh to eleventh aspects may be such that the first electrode forms at least a portion of a cathode, and the second electrode forms an anode. In this case, it is possible to provide a capacitor in which the second electrode including a valve metal functions as the anode.

An electrical circuit according to a thirteenth aspect of the present disclosure includes the capacitor according to any one of the seventh to twelfth aspects. According to the thirteenth aspect, the capacitor is likely to have a high capacitance and the electrical circuit is likely to exhibit a desired performance.

A circuit board according to a fourteenth aspect of the present disclosure includes the capacitor according to any one of the seventh to twelfth aspects. According to the fourteenth aspect, the capacitor is likely to have a high capacitance and the circuit board is likely to exhibit a desired performance.

An apparatus according to a fifteenth aspect of the present disclosure includes the capacitor according to any one of the seventh to twelfth aspects. According to the fifteenth aspect, the capacitor is likely to have a high capacitance and the apparatus is likely to exhibit a desired performance.

A power storage device according to a sixteenth aspect of the present disclosure includes the capacitor according to any one of the seventh to twelfth aspects. According to the sixteenth aspect, the capacitor is likely to have a high capacitance and the power storage device is likely to exhibit a desired performance.

### Embodiments

Embodiments of the present disclosure are described below with reference to the drawings. The present disclosure is not limited to the following embodiments.

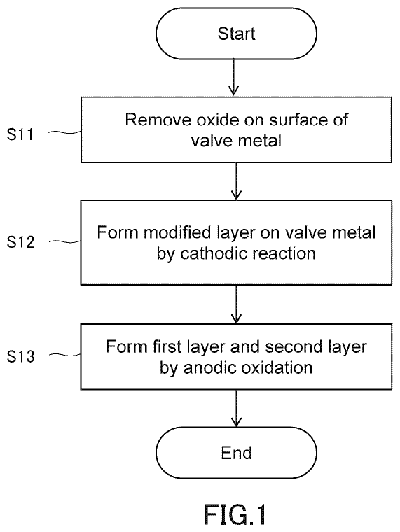

FIG. 1 is a flowchart showing an example of a method for manufacturing a member of a capacitor. The method for manufacturing the member of a capacitor includes forming a modified layer on a valve metal by a cathodic reaction, and the modified layer includes a metal other than the valve metal. In this manufacturing method, a requirement ε_{H}/K_{H} [V/nm]>ε_{L}/K_{L} [V/nm] is satisfied. By forming such a modified layer by a cathodic reaction, it is possible to form a metal-containing layer derived from the modified layer on a layer including a valve metal oxide by a given treatment following the cathodic reaction. Therefore, a member of a capacitor to be manufactured is advantageous for increasing the capacitance of a capacitor. The metal included in the above modified layer may be a valve metal different from the above valve metal. In the above requirement, ε_{H} is the dielectric constant of an oxide of the above metal included in the modified layer, and K_{H} [nm/V] is the thickness of a first oxide film of the metal, in formation of the first oxide film by anodic oxidation of the metal, per 1 V of anode potential. In addition, ε_{L} is the dielectric constant of an oxide of the above valve metal, and K_{L} [nm/V] is the thickness of a second oxide film including the oxide of the valve metal, in formation of the second oxide film by anodic oxidation, per 1 V of anode potential.

In the above manufacturing method, the combination of the above valve metal and the above metal included in the modified layer is not limited to any particular combination as long as the requirement ε_{H}/K_{H} [V/nm]>ε_{L}/K_{L} [V/nm] is satisfied. Examples of the combination include a combination of aluminum (Al) and cerium (Ce), a combination of Al and tungsten (W), a combination of tantalum (Ta) and Ce, and a combination of Ta with W. Furthermore, reference may be made to the values of ε/K in the metal oxides listed in Table 1 to determine the combination of the above valve metal and the above metal included in the modified layer where the requirement ε_{H}/K_{H} [V/nm]>ε_{L}/K_{L} [V/nm] is satisfied.

As shown in FIG. 1, for example, in Step S11, an oxide on the surface of the valve metal is removed. Next, in Step S12, the above modified layer is formed on the valve metal by a cathodic reaction of the valve metal in a solution including a given metal other than a valve metal.

As shown in FIG. 1, this method for manufacturing the member of a capacitor, further includes, for example, forming a first layer and a second layer by anodic oxidation of the above valve metal and the above modified layer, and the first layer includes a given metal and the second layer includes an oxide of the above valve metal (see Step S13). The first layer includes the above metal included in the modified layer. In this case, the anodic oxidation of the valve metal and the modified layer can form the first layer derived from the modified layer on the layer including the valve metal oxide. Therefore, a member of a capacitor to be manufactured is advantageous for increasing the capacitance of a capacitor.

In anodic oxidation of a valve metal, an outer oxide layer is formed by migration of valve metal ions, and an inner oxide layer is formed by migration of oxide ions. Here, while the inner oxide layer is an oxide layer that is formed in contact with the valve metal, the outer oxide layer is an oxide layer that is formed on the above inner oxide layer and out of contact with the valve metal. In the outer oxide layer, a component contained in a solution used for anodic oxidation can be incorporated. In contrast, the inner oxide layer is a dense layer formed of the oxide of the valve metal and hardly includes the component contained in the solution used for anodic oxidation. The ratio of the thickness of the outer oxide layer to the thickness of the entire oxide layer formed by anodic oxidation of the valve metal is determined by the type of valve metal. Table 2 shows this ratio for aluminum (Al), niobium (Nb), and tantalum (Ta). As shown in Table 2, the ratio is less than 0.5, demonstrating that, only by anodic oxidation of the valve metal, it is difficult to form a layer including a given metal on a layer including a valve metal oxide to a thickness of 50% or more of the thickness of the entire layer.

TABLE 2

| | Ratio of thickness of outer oxide layer |
|---|---|
| Type of | to thickness of entire oxide layer |
| valve metal | formed by anodic oxidation of valve metal |
| Al | 0.44 |
| Nb | 0.239 |
| Ta | 0.243 |

In the above method for manufacturing the member of a capacitor, in contrast, the first layer can be formed by anodic oxidation of the above modified layer formed by a cathodic reaction. This is likely to increase the ratio of the thickness of the first layer to the thickness of the entire resulting dielectric layer. For example, the ratio of the thickness of the first layer to the sum of the thickness of the first layer and the thickness of the second layer can be adjusted to 50% or more.

The metal included in the above modified layer is not limited to any particular metal as long as the requirement ε_{H}/K_{H} [V/nm]>ε_{L}/K_{L} [V/nm] is satisfied. This metal is, for example, cerium. As described above, since CeO₂ has higher ε/K than Al₂O₃ and Ta₂O₅, which are commonly used as dielectrics in electrolytic capacitors, a member of a capacitor to be manufactured is more advantageous for increasing the capacitance of a capacitor. The metal included in the above modified layer may be tungsten.

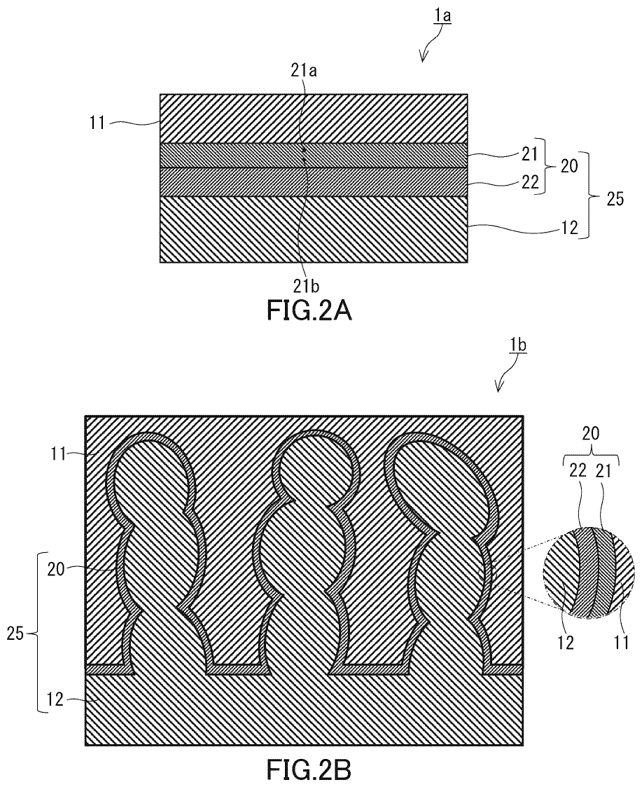

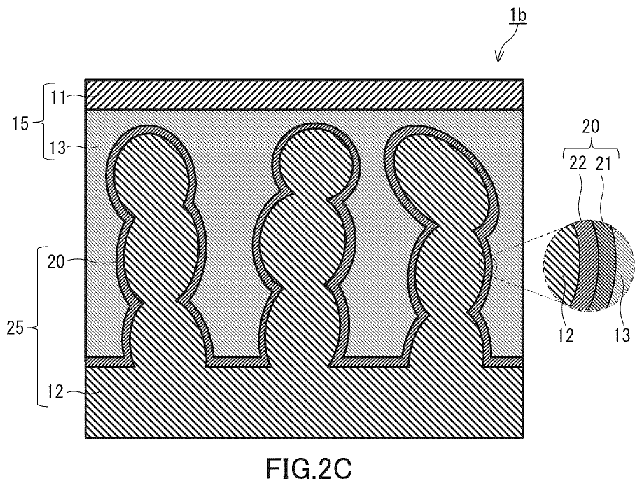

FIG. 2A is a cross-sectional view showing an example of a capacitor of the present disclosure. As shown in FIG. 2A, a capacitor 1a includes a first electrode 11, a second electrode 12, and a dielectric 20. The second electrode 12 includes a valve metal. Furthermore, the second electrode 12 has a cerium content of less than 0.1% in terms of number of atoms. The dielectric 20 is disposed between the first electrode 11 and the second electrode 12. The dielectric 20 includes a first layer 21 including cerium and a second layer 22 including a valve metal oxide. The first layer 21 is disposed between the second layer 22 and the first electrode 11 in the thickness direction of the first layer 21. In the thickness direction of the first layer 21, the second layer 22 is disposed between the first layer 21 and the second electrode 12 and is in contact with the second electrode 12. Since the dielectric 20 includes the first layer 21 including cerium, the dielectric 20 is likely to have increased ε/K and the capacitor 1a is likely to have a high capacitance.

The valve metal included in the second electrode 12 is not limited to any particular valve metal. The valve metal included in the second electrode 12 is, for example, aluminum. Aluminum is a relatively readily available metal, facilitating the manufacturing of the capacitor 1a. In addition, after the use of the capacitor 1a, aluminum included in the second electrode 12 can be recovered as a recycled resource. The valve metal included in the second electrode 12 may be a valve metal other than aluminum, such as tantalum.

The surface of the valve metal can be made porous by etching or the like. In this case, impurities included in the valve metal can have a significant impact on the pore formation. In addition, impurities included in the valve metal can have a significant impact even on the electrical properties of a dielectric film obtained by a chemical conversion treatment of the valve metal. The second electrode 12 has a cerium content of less than 0.1% in terms of number of atoms, as described above. In the case where the surface of the second electrode 12 is made porous, cerium is less prone to have an impact on the pore formation. Therefore, the capacitor 1a is likely to have a high capacitance. The second electrode 12 may have a cerium content of 0.01% or less or 0.001% or less in terms of number of atoms. The second electrode 12 may be entirely free of cerium.

In the first layer 21, cerium is present, for example, as a cerium oxide. Therefore, the dielectric 20 is likely to have increased ε/K and the capacitor 1a is likely to have a high capacitance. The cerium oxide may be amorphous or polycrystalline.

The first layer 21 may further include, for example, a valve metal oxide. The valve metal oxide included in the first layer 21 is not limited to any particular valve metal oxide. In the case where the valve metal included in the second electrode 12 is aluminum, the valve metal oxide included in the first layer 21 may be an aluminum oxide. The valve metal oxide included in the first layer 21 may be a valve metal oxide other than an aluminum oxide, such as a tantalum oxide.

The valve metal oxide included in the second layer 22 is not limited to any particular valve metal oxide. In the case where the valve metal included in the second electrode 12 is aluminum, the valve metal oxide included in the second layer 22 may be an aluminum oxide. The valve metal oxide included in the second layer 22 may be a valve metal oxide other than an aluminum oxide, such as a tantalum oxide.

The thickness of the dielectric 20 is not limited to any particular value. The thickness of the dielectric 20 is, for example, 5 nm to 800 nm. In this case, the capacitor 1a is likely to have a high capacitance and the dielectric 20 is likely to be formed uniformly. The thickness of the dielectric 20 may be 10 nm to 400 nm or 20 nm to 100 nm.

The thickness of the first layer 21 is not limited to any particular value. The thickness of the first layer 21 is, for example, 2 nm to 800 nm. In this case, the capacitor 1a is likely to have a high capacitance and the first layer 21 is likely to be formed uniformly. The thickness of the first layer 21 may be 4 nm to 400 nm or 10 nm to 100 nm.

The ratio of the thickness of the first layer 21 to the sum of the thickness of the first layer 21 and the thickness of the second layer 22 is not limited to any particular value. This ratio is, for example, 50% or more. Therefore, the capacitor 1a is more likely to have a high capacitance. The ratio may be 55% or more, 60% or more, 65% or more, 70% or more, 75% or more, or 80% or more. The ratio is, for example, 99% or less.

The thickness of the second layer 22 is not limited to any particular value. The thickness of the second layer 22 is, for example, 5 nm to 200 nm. In this case, the capacitor 1a is likely to have a high capacitance and the first layer 21 is likely to be formed uniformly.

The cerium concentration distribution in the first layer 21 is not limited to any particular distribution. For example, the first layer 21 has a lower cerium concentration at a second position 21b thereof than at a first position 21a thereof. In the thickness direction of the first layer 21, the second position 21b is closer to the second layer 22 than the first position 21a of the first layer 21 is. With such a configuration, the cerium concentration in the first layer 21 is likely to achieve a desired distribution and the capacitor 1a is likely to have a high capacitance. The cerium concentration in the first layer 21 can be determined, for example, on the basis of TOF-SIMS measurement results.

The cerium concentrations in n layered portions, obtained by equally dividing the first layer 21 into n sections in the thickness direction, satisfy the relationship Cᵢ₊₁<Cᵢ, for example. In this relationship, when the portion farthest from the second electrode 12 among the n layered portions is defined as the 1st portion satisfying i=1, Cᵢ₊₁ denotes the cerium concentration in terms of number of atoms at the (i+1)-th portion farther from the second electrode 12. When the portion farthest from the second electrode 12 among the n layered portions is defined as the 1st portion satisfying i=1, Cᵢ denotes the cerium concentration in terms of number of atoms at the i-th portion farther from the second electrode 12. Here, i denotes any of the consecutive integers from 1 to n−1,where n is an integer equal to or greater than 2. In this case, the n layered portions, obtained by equally dividing the first layer 21 into the n sections in the thickness direction, each have a thickness of, for example, 5 nm to 20 nm.

The material of the first electrode 11 is not limited to any particular material. The first electrode 11 may include a valve metal, or may include a metal other than a valve metal. The metal other than a valve metal may be a noble metal, such as gold or platinum, or may be nickel. The first electrode 11 may include a carbon material, such as graphite. The first electrode 11 may include a conductive polymer. In this case, the conductive polymer may be polypyrrole, polythiophene, poly(3,4-ethylenedioxythiophene)-poly(styrenesulfonate), or a mixed material of these.

In the capacitor 1a, for example, the first electrode 11 forms at least a portion of the cathode. In addition, the second electrode 12 forms the anode. With such a configuration, it is possible to provide a capacitor in which the second electrode 12 including a valve metal functions as the anode. The capacitor 1a may be configured such that the first electrode 11 forms the anode and the second electrode 12 forms the cathode.

FIG. 2B is a cross-sectional view showing another example of the capacitor of the present disclosure. A capacitor 1b shown in FIG. 2B is configured in the same manner as the capacitor 1a unless otherwise described. Components of the capacitor 1b that are the same as or correspond to the components of the capacitor 1a are denoted by the same reference characters, and the detailed description is omitted. The description for the capacitor 1a also applies to the capacitor 1b unless there is a technical inconsistency.

As shown in FIG. 2B, at least a portion of the second electrode 12 included in the capacitor 1b is porous. With such a configuration, the second electrode 12 is likely to have an increased surface area and the capacitor 1b is likely to have an increased capacitance. Such a porous structure can be formed, for example, by etching of a metal foil or sintering of a powder.

As shown in FIG. 2B, the dielectric 20 is disposed on the surface of the porous portion of the second electrode 12. In the capacitor 1b, the first electrode 11 is disposed, for example, to fill a space around the porous portion of the second electrode 12.

The capacitors 1a and 1b may be electrolytic capacitors. In this case, an electrolyte 13 is disposed between the first electrode 11 and the dielectric 20. FIG. 2C shows a modification of the capacitor 1b configured as an electrolytic capacitor. In the capacitor 1b according to the modification, the electrolyte 13 is disposed, for example, to fill the space around the porous portion of the second electrode 12. In the capacitor 1b, for example, the first electrode 11 and the electrolyte 13 form a cathode 15.

The electrolyte includes, for example, at least one selected from the group consisting of an electrolyte solution and an electrically conductive polymer. Examples of the electrically conductive polymer include polypyrrole, polythiophene, polyaniline, and derivatives of these polymers. The electrolyte may be made of a manganese compound, such as manganese oxide. The electrolyte may include a solid electrolyte.

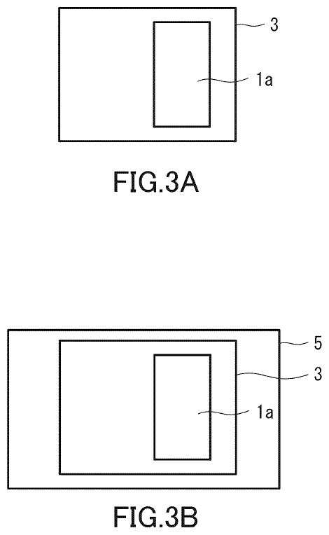

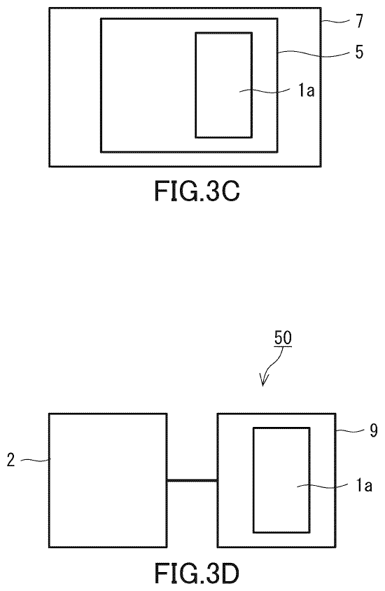

For example, it is possible to provide an electrical circuit including the capacitor 1a or 1b. FIG. 3A schematically shows an example of an electrical circuit of the present disclosure. An electrical circuit 3 includes the capacitor 1a. The electrical circuit 3 may be an active circuit or a passive circuit. The electrical circuit 3 may be a discharge circuit, a smoothing circuit, a decoupling circuit, or a coupling circuit. Since the electrical circuit 3 includes the capacitor 1a, the electrical circuit 3 is likely to exhibit a desired performance.

For example, it is possible to provide a circuit board including the capacitor 1a or 1b. FIG. 3B schematically shows an example of a circuit board of the present disclosure. As shown in FIG. 3B, a circuit board 5 includes the capacitor 1a. For example, on the circuit board 5, the electrical circuit 3 including the capacitor 1a is formed. Since the circuit board 5 includes the capacitor 1a, the circuit board 5 is likely to exhibit a desired performance.

For example, it is possible to provide an apparatus including the capacitor 1a or 1b. FIG. 3C schematically shows an example of an apparatus of the present disclosure. As shown in FIG. 3C, an apparatus 7 includes the capacitor 1a. The apparatus 7 includes, for example, the circuit board 5 including the capacitor 1a. Since the apparatus 7 includes the capacitor 1a, the apparatus 7 is likely to exhibit a desired performance. The apparatus 7 may be an electronic device, a communication device, a signal processing device, or a power supply device. The apparatus 7 may be a server, an AC adapter, an accelerator, or a flat-panel display, such as a liquid crystal display (LCD). The apparatus 7 may be a USB charger, a solid-state drive (SSD), an information terminal, such as a PC, a smartphone, or a tablet PC, or an Ethernet switch.

For example, it is possible to provide a power storage device including the capacitor 1a or 1b. FIG. 3D schematically shows an example of a power storage device of the present disclosure. As shown in FIG. 3D, a power storage device 9 includes the capacitor 1a. With this configuration, the power storage device 9 is likely to exhibit a desired performance. As shown in FIG. 3D, for example, it is possible to provide a power storage system 50 by using the power storage device 9. The power storage system 50 includes the power storage device 9 and a power generation apparatus 2. In the power storage system 50, electricity obtained from power generation in the power generation apparatus 2 is stored in the power storage device 9. The power generation apparatus 2 is, for example, an apparatus for solar power generation or wind power generation. The power storage device 9 includes, for example, a secondary battery, such as a lithium-ion battery or a lead-acid battery.

A method for manufacturing the capacitor 1a or 1b is not limited to any particular method. The capacitor 1a or 1b can be manufactured, for example, by using a member 25 of a capacitor. As shown in FIGS. 2A, 2B, and 2C, the member 25 of a capacitor includes the second electrode 12 and the dielectric 20.

A method for manufacturing the member 25 of a capacitor is not limited to any particular method. For example, the member 25 of a capacitor can be manufactured by a method including (I) and (II) below:
(I) forming a cerium-containing layer including cerium on a valve metal by a cathodic reaction of the valve metal in a cerium-containing solution; and
(II) forming the first layer 21 including cerium and the second layer 22 including a valve metal oxide by anodic oxidation of the valve metal and the cerium-containing layer.

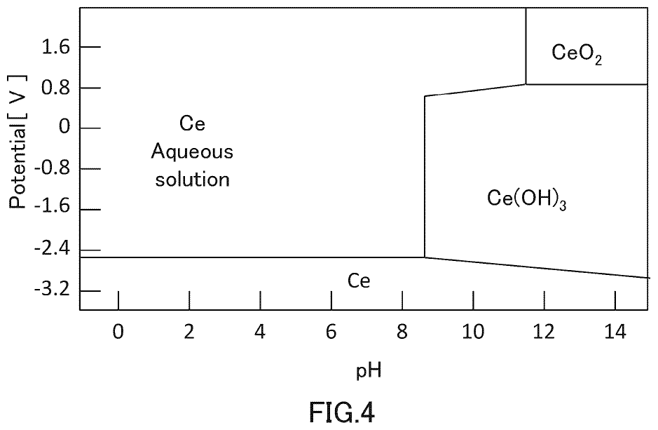

FIG. 4 is a potential-pH diagram showing the state of cerium in water. As shown in FIG. 4, under neutral conditions where the pH is around 7, cerium is present in water as trivalent or tetravalent ions and exhibits water solubility. For example, the pH for forming a dielectric layer by anodic oxidation of Al can be adjusted to 5 to 7 (Sulka, Grzegorz D. “Highly ordered anodic porous alumina formation by self-organized anodizing.” Nanostructured materials in electrochemistry (2008): 1-116). Accordingly, it is difficult to form a layer including cerium by using an aqueous solution used for anodic oxidation. In (I) above, on the other hand, it is possible to form a cerium-containing layer on a valve metal by a cathodic reaction of the valve metal in a cerium-containing solution.

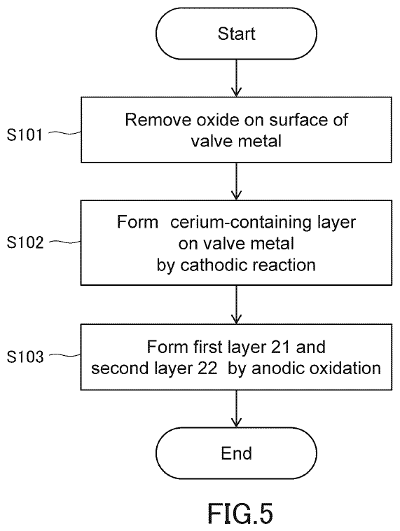

FIG. 5 is a flowchart showing an example of the method for manufacturing the member 25 of a capacitor. In Step S101, an oxide on the surface of a valve metal is removed. Next, in Step S102, a cerium-containing layer including cerium is formed on the valve metal by a cathodic reaction of the valve metal in a cerium-containing solution. Next, in Step S103, the first layer 21 including cerium and the second layer 22 including a valve metal oxide are formed by anodic oxidation of the valve metal and the cerium-containing layer.

As shown in FIG. 4, adjusting the pH of the cerium-containing solution to approximately 8.5 allows cerium to be deposited as Ce(OH)₃ on the valve metal. The cerium-containing solution in (I) above includes, for example, hydrogen peroxide. In this case, due to the cathodic reaction, the hydrogen peroxide included in the cerium-containing solution is involved in the reaction given by the following Equation (3). In Equation (3), *OH denotes a hydroxyl radical.

$${H}_{2} {O}_{2} + {e}^{-} {\to }^{*} OH + {OH}^{-} \qquad Equation ( 3 )$$

The reaction given by Equation (3) is an electrochemical reaction that occurs near the cathode, and adjusting the amount of the reaction product from Equation (3) is relatively easy. The OH-generated in Equation (3) raises the pH of the cerium-containing solution around the cathode in the cathodic reaction. Accordingly, referring to FIG. 4, Ce(OH)₃ can be deposited on the valve metal serving as the cathode due to the reaction given by Equation (3). Ce(OH)₃ is an electrical insulator and has low conductivity. This easily causes, in the cathodic reaction, a deposition reaction of Ce(OH)₃ in regions of the surface of the valve metal that are not coated with Ce(OH)₃. Consequently, the entire surface of the valve metal becomes coated with Ce(OH)₃, forming a cerium-containing layer. The mechanism of Ce(OH)₃ deposition also applies to a case where a porous portion is formed on the surface of the valve metal. Therefore, in the case where a porous portion is formed on the surface of the valve metal, Ce(OH)₃ can be deposited to uniformly coat the porous portion on the surface of the valve metal.

By the anodic oxidation of the valve metal and the cerium-containing layer in (II) above, Ce(OH)₃ is oxidized to be transformed into CeO₂. In addition, oxide ions O²⁻ are led to the boundary between the valve metal and the cerium-containing layer, oxidizing the valve metal present near the boundary to be transformed into a valve metal oxide. Thus, the first layer 21 including cerium and the second layer 22 including the valve metal oxide are formed, obtaining the member 25 of a capacitor.

In the anodic oxidation in (II) above, an electrolyte solution including an organic solvent is used, for example. As described above, Ce has water solubility under neutral conditions. On the other hand, tetravalent cerium has low solubility in organic solvents. Accordingly, owing to the use of an electrolyte solution including an organic solvent for anodic oxidation, cerium is less prone to elution into the electrolyte solution and the first layer 21 is likely to have an increased cerium concentration.

The organic solvent included in the electrolyte solution is not limited to any particular organic solvent. The organic solvent may be a polyhydric alcohol, such as ethylene glycol, ethylene glycol monomethyl ether, γ-butyrolactone, or N-methylformamide.

The capacitor 1a or 1b is obtained by disposing the first electrode 11 relative to the member 25 of a capacitor such that the dielectric 20 is positioned between the second electrode 12 and the first electrode 11.

### EXAMPLE

The present disclosure is described below in more detail with reference to an example. The following example is only exemplary and the present disclosure is not limited to the following example.

### Example

To remove a native oxide film adhering to the surface of an aluminum plate (purity 99+%) manufactured by the Nilaco Corporation, electropolishing was performed. The polishing solution used was a liquid mixture of perchloric acid manufactured by FUJIFILM Wako Pure Chemical Corporation and an aqueous ethanol solution. The HClO₄ concentration in the perchloric acid was 70 mass %. The ethanol concentration in the aqueous ethanol solution was 96 mass %. Approximately 80 ml of the polishing solution was poured into a beaker, and both the cathode and the anode were immersed in the polishing solution to a depth of approximately 3 cm. The aluminum plate was connected to a DC power supply PSF-L manufactured by TEXIO TECHNOLOGY CORPORATION using an alligator clip, and a current of 2 A was applied for 10 seconds to remove the oxide film from the anode-side surface of the aluminum plate. The aluminum plate, from which the oxide film had been removed, was rinsed twice with pure water and then immersed in a pH 7 phosphoric acid buffer solution for 3 minutes to prevent natural oxidation. The chemical solution was then washed off with running water for 10 minutes, obtaining an aluminum plate of a capacitor.

Next, a cerium-containing layer was formed on the aluminum plate of a capacitor by a cathodic reaction of the aluminum plate of a capacitor. Cerium(III) acetate monohydrate (Ce(CH₃COO)₃·H₂O) manufactured by FUJIFILM Wako Pure Chemical Corporation and a hydrogen peroxide solution manufactured by FUJIFILM Wako Pure Chemical Corporation were dissolved in water to obtain a cerium-containing solution. The H₂O₂ concentration in the hydrogen peroxide solution was 30 mass %. The Ce concentration in the cerium-containing solution was 5 millimoles per cubic decimeter (mmol/dm³), and the H₂O₂ concentration in the cerium-containing solution was 4.9 mol/dm³. Approximately 80 ml of the cerium-containing solution was poured into a beaker, and the aluminum plate serving as the cathode and a porous carbon body serving as the anode were fixed in the cerium-containing solution. The cathode and the anode were each connected to a current source and a current of 0.01 A was applied for 60 seconds. A yellow layer (cerium-containing layer) was formed on the entire surface, immersed in the cerium-containing solution, of the aluminum plate. The aluminum plate was washed with running water so as not to damage the cerium-containing layer.

Next, an anodic oxidation treatment was performed. Dipotassium hydrogen phosphate (K₂HPO₄) was dissolved in ethylene glycol (HO—CH₂—CH₂—OH) manufactured by FUJIFILM Wako Pure Chemical Corporation to obtain an electrolyte solution. The concentration of the dipotassium hydrogen phosphate in the electrolyte solution was 0.1 mol/dm³. Approximately 80 ml of the electrolyte solution was poured into a beaker, and the aluminum plate, on which the cerium-containing layer had been formed, serving as the anode and a metallic tantalum plate serving as the cathode were fixed in the electrolyte solution. The anode and the cathode were each connected to a current source and a voltage of 80 V was applied for 1.5 hours. Thus, an oxide film was formed on the aluminum plate. The aluminum plate, on which the oxide film had been formed, was washed with running water for 10 minutes and dried naturally. Thus, a member of a capacitor according to the example was obtained.

### Crystallinity Evaluation

The X-ray diffraction (XRD) pattern of the member of a capacitor according to the example was obtained through 2θ/θ scanning using an X-ray diffractometer X'Pert PRO manufactured by Malvern Panalytical Ltd. The member of a capacitor according to the example was placed on the sample table of the X-ray diffractometer to obtain the XRD pattern. Cu-Ka radiation was used as the X-ray source, the voltage was adjusted to 45 kV, the current was adjusted to 40 mA, and the scanning speed was adjusted to 12 deg./min. To confirm the positions of X-ray diffraction peaks, the XRD pattern of pure aluminum (Al) and the powder XRD pattern of CeO₂ were calculated using RIETAN FP (F. Izumi and K. Momma, Solid State Phenom., 130, 15-20 (2007)).

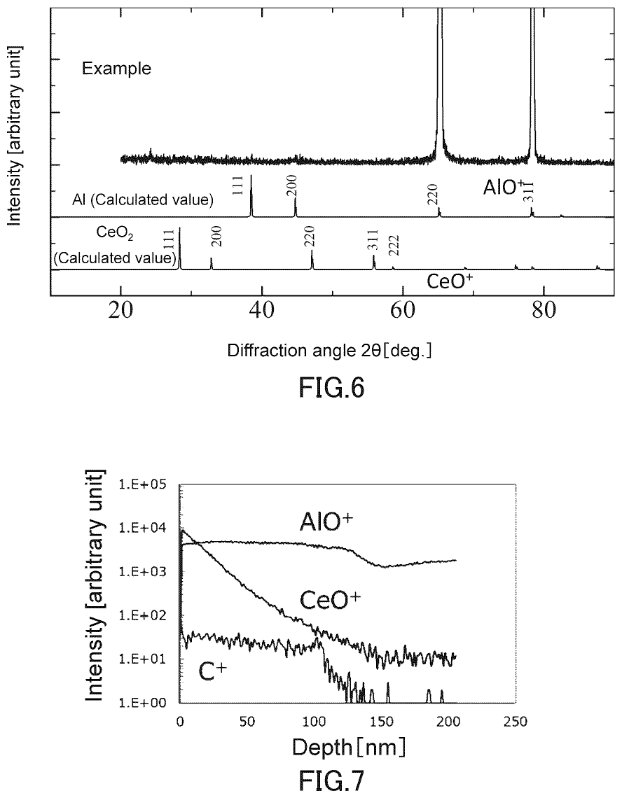

FIG. 6 is a graph showing the XRD pattern of the member of a capacitor according to the example and the results of calculating the XRD patterns of Al and CeO₂. The XRD pattern at the top in FIG. 6 is the XRD pattern of the member of a capacitor according to the example. The XRD pattern second from the top in FIG. 6 is the result of calculating the XRD pattern of Al. The XRD pattern at the bottom in FIG. 6 is the result of calculating the XRD pattern of crystalline CeO₂. In FIG. 6, the vertical axis represents the diffraction intensity, while the horizontal axis represents the diffraction angle 20. The vertical axis in FIG. 6 shows the relative relationship of diffraction intensity in each of the XRD patterns and does not show the relative relationship of diffraction intensity between different XRD patterns. In the XRD pattern of the member of a capacitor according to the example, a peak identified as Al is confirmed, while a peak attributed to crystalline CeO₂ is not confirmed. From this, it is considered that amorphous CeO₂ is present in the oxide film of the member of a capacitor according to the example.

### Compositional Analysis in Depth Direction

TOF-SIMS was performed on the oxide film formed on the member of a capacitor according to the example using a TOF-SIMS device TOF. SIMS5 manufactured by IONTOF GmbH, and compositional analysis of the oxide film in the depth direction was performed. In the TOF-SIMS, the primary ion beam used was a Bi³⁺ beam accelerated at 30 kV, and the sputtering ion species used was O₂⁺, which has high sensitivity to Al.

FIG. 7 is a graph showing, as determined by the TOF-SIMS on the member of a capacitor according to the example, the relationship between the signal intensities of aluminum oxide ions (AlO⁺), cerium oxide ions (CeO⁺), and carbon ions (C⁺) and the depth of the member of a capacitor. It is indicated that Al, Ce, or C is present at a depth where the signal intensity was observed. The signal intensity in TOF-SIMS shows the quantity of the element present and is semi-quantitative. FIG. 7 demonstrates that the signal intensity of CeO⁺ decreases exponentially from the surface of the oxide film. The signal intensity of AlO⁺ remains almost unchanged to a depth of 130 nm. On the other hand, this signal intensity decreases at depths of 130 nm or more. From the above, it is understood that the oxide film extends to a depth of 130 nm, and beyond this depth, the analysis reaches the aluminum plate, resulting in lower signal intensity of AlO⁺ at depths of 130 nm or more.

FIG. 7 demonstrates that the majority of the oxide film is occupied by an aluminum oxide, and a layer having a distribution of a Ce concentration decreasing inwards is formed as the outer portion of the oxide film. In other words, the oxide film of the member of a capacitor according to the example includes: an outer layer including cerium and the aluminum oxide; and an inner layer including the aluminum oxide. A possible reason that the outer layer of the oxide film has the distribution of the Ce concentration decreasing inwards is the migration of Al to the cerium-containing layer occurred along with the growth of the oxide film due to anodic oxidation. TOF-SIMS was performed on multiple locations of the member of a capacitor according to the example. The results show that the average thickness of the oxide film was 95 nm, calculated from the sum of the thickness of the outer layer and the thickness of the inner layer.

Focusing on the signal intensity of C⁺ in FIG. 7, it is understood that C is present in the outer layer including cerium and the aluminum oxide, while C is hardly present in the inner layer including the aluminum oxide. The presence of C in the outer layer is considered to be derived from the cerium(III) acetate monohydrate used for the cathodic reaction of the aluminum plate of a capacitor. For this reason, the outer layer is considered to be a layer derived from the cerium-containing layer formed by the cathodic reaction. FIG. 7 demonstrates that the ratio of the thickness of the outer layer to the sum of the thickness of the outer layer and the thickness of the inner layer is approximately 80%.

### AC Impedance Measurement

To measure leakage current and evaluate capacitance, the member of a capacitor according to the example was subjected to AC conductivity measurement using an impedance analyzer. The impedance analyzer was configured by combining a frequency response analyzer Model 1260A and a potentiostat Model 1287A manufactured by Solartron Analytical. This impedance analyzer was used to perform AC conductivity measurement in which an ammonium adipate ((NH₄)₂(CH₂)₄(COO)₂) solution with a concentration of 0.5 mol/dm³ was used as the cathode in combination with the member of a capacitor. The dielectric constant & of the oxide film was calculated from the capacitance value obtained by the AC conductivity measurement, the thickness of the oxide film determined by the above cross-sectional structure analysis, and the measurement area in the AC conductivity measurement.

Table 3 shows the dielectric constant & of the oxide film determined from the capacitance obtained by the AC conductivity measurement, the proportionality constant K [nm/V] between the thickness of the oxide film and the applied voltage in oxide film formation, and ε/K [V/nm]. For comparison, the table also includes transcription of the corresponding values for Al₂O₃ given in Atsushi TANAKA and Hideaki TAKAHASHI: “The Structure and Growth Mechanism of Anodic Barrier Films of Aluminum”, Journal of the Surface Finishing Society of Japan, 2018, 69(12), 542-553. The comparison between these shows that, in the member of a capacitor according to the example, owing to the inclusion of the outer layer including cerium in the oxide film, the oxide film had a higher dielectric constant and a lower proportionality constant K. As a result, the oxide film of the member of a capacitor according to the example had higher ε/K.

TABLE 3

| | Dielectric | K | ε/K |
|---|---|---|---|
| | constant ε | [nm/V] | [V/nm] |
| Example | 13.5 | 1.25 | 10.8 |
| Al₂O₃ | 9.8 | 1.4 | 7 |

### INDUSTRIAL APPLICABILITY

The capacitor according to the present disclosure is likely to have a high capacitance and is useful.

What is claimed is:

1. A method for manufacturing a member of a capacitor, the method comprising forming a modified layer on a valve metal by a cathodic reaction, the modified layer including a metal other than the valve metal, wherein
a requirement ε_{H}/K_{H} [V/nm]>ε_{L}/K_{L} [V/nm] is satisfied, where
ε_{H} is a dielectric constant of an oxide of the metal,
K_{H} [nm/V] is a thickness of a first oxide film of the metal, in formation of the first oxide film by anodic oxidation of the metal, per 1 V of anode potential,
ε_{L} is a dielectric constant of an oxide of the valve metal, and
K_{L} [nm/V] is a thickness of a second oxide film including the oxide of the valve metal, in formation of the second oxide film by anodic oxidation, per 1 V of anode potential.

2. The method according to claim 1, further comprising forming a first layer and a second layer by anodic oxidation of the valve metal and the modified layer, the first layer including the metal, the second layer including the oxide of the valve metal.

3. The method according to claim 1, wherein
the metal is cerium.

4. A method for manufacturing a member of a capacitor, the method comprising:
forming a cerium-containing layer including cerium on a valve metal by a cathodic reaction of the valve metal in a cerium-containing solution; and
forming a first layer and a second layer by anodic oxidation of the valve metal and the cerium-containing layer, the first layer including cerium, the second layer including a valve metal oxide, wherein
in a thickness direction of the first layer, the second layer is disposed between the first layer and the valve metal and is in contact with the valve metal.

5. The method according to claim 4, wherein
the cerium-containing solution includes hydrogen peroxide.

6. The method according to claim 5, wherein
an electrolyte solution including an organic solvent is used for the anodic oxidation.

7. A capacitor comprising:
a first electrode;
a second electrode including a valve metal and having a cerium content of less than 0.1% in terms of number of atoms; and
a dielectric disposed between the first electrode and the second electrode, wherein
the dielectric includes:
a first layer including cerium; and
a second layer including a valve metal oxide and being, in a thickness direction of the first layer, disposed between the first layer and the second electrode and in contact with the second electrode.

8. The capacitor according to claim 7, wherein
the first layer further includes a valve metal oxide.

9. The capacitor according to claim 7, wherein
the valve metal included in the second electrode is aluminum.

10. The capacitor according to claim 7, wherein
the valve metal oxide included in the second layer is an aluminum oxide.

11. The capacitor according to claim 7, wherein
the first layer has a lower cerium concentration at a second position thereof than at a first position thereof, the second position being closer to the second layer than the first position is in the thickness direction of the first layer.

12. The capacitor according to claim 7, wherein
the first electrode forms at least a portion of a cathode, and
the second electrode forms an anode.

13. An electrical circuit comprising the capacitor according to claim 7.

14. A circuit board comprising the capacitor according to claim 7.

15. An apparatus comprising the capacitor according to claim 7.

16. A power storage device comprising the capacitor according to claim 7.
